(19) United States
(12) Patent Application Publication
(10) Pub. No.: US 2026/0164000 A1
(43) Pub. Date: Jun. 11, 2026

(54) PROJECTION APPARATUS WITH DYNAMIC DEPTH SENSING AND PROJECTION METHOD THEREOF

(71) Applicant: COMPAL ELECTRONICS, INC., Taipei City (TW)

(72) Inventors: Meng-Huan Tsai, Taipei City (TW); Hua Liu, Taipei City (TW); Chen-Cheng Wang, Taipei City (TW); Kung-Ju Chen, Taipei City (TW)

(73) Assignee: COMPAL ELECTRONICS, INC., Taipei City (TW)

(21) Appl. No.: 19/408,400

(22) Filed: Dec. 4, 2025

Related U.S. Application Data
(60) Provisional application No. 63/729,453, filed on Dec. 8, 2024.

(30) Foreign Application Priority Data
Jul. 22, 2025 (TW) 114127771

(51) Int. Cl. H04N 9/31; G01B 21/18

(52) U.S. Cl. CPC H04N 9/3188; G01B 21/18

(57) ABSTRACT

A projection apparatus with dynamic depth sensing and a projection method thereof are provided. The projection apparatus comprising a projection unit, a depth sensing unit, and a processor. The depth sensing unit is disposed to maintain a fixed relative positional relationship with the projection unit, and is disposed with the projection unit to face the same direction at the same viewing angle. The processor is configured to: project a projection image containing a target object to a projection target through the projection unit; obtain a distance parameter representing the distance from the projection unit to the projection target through the depth sensing unit; and adjust the target object in the projection image based on the distance parameter. Regardless of the distance, it does not affect the size of the target object in the projection image.

### CROSS-REFERENCE TO RELATED APPLICATION

This application claims the priority benefits of U.S. application Ser. No. 63/729,453, filed on Dec. 8, 2024, and Taiwan application serial no. 114127771, filed on Jul. 22, 2025. The entirety of each of the above-mentioned patent applications is hereby incorporated by reference herein and made a part of this specification.

### BACKGROUND

### Technical Field

This disclosure relates to a projection apparatus and a projection method, and particularly relates to a projection apparatus with dynamic depth sensing and a projection method.

### Description of Related Art

In the prior art, the projection image size and the size of content objects in the image of general projection systems maintain a fixed ratio. If the projection image size is changed, the size of content objects in the image will be scaled proportionally, and simultaneously the physical position of content objects in the image on the projection target will change. Such projection systems are not convenient to use in some specific occasions.

### SUMMARY

In view of this, this disclosure provides a projection apparatus with dynamic depth sensing and a projection method. A projection apparatus with dynamic depth sensing of this disclosure includes a projection unit, a depth sensing unit, and a processor. The depth sensing unit is disposed to maintain a fixed relative position relationship with the projection unit, and is disposed with the projection unit to face the same direction at the same viewing angle. The processor is coupled to the projection unit and the depth sensing unit. The processor is configured to: project a projection image having a target object to a projection target through the projection unit; obtain a distance parameter representing a distance from the projection unit to the projection target through the depth sensing unit; and adjust the target object in the projection image based on the distance parameter.

A projection method with dynamic depth sensing of this disclosure includes the following. A projection image having a target object is projected to a projection target through the projection unit. A distance parameter representing a distance from the projection unit to the projection target is obtained through the depth sensing unit. The target object in the projection image is adjusted based on the distance parameter.

Based on the above, the projection apparatus with dynamic depth sensing and the projection method of the disclosure may utilize the technology of projector combined with depth measurement to achieve that under any scaling size of the projection image, the size and relative position of content objects in the projection image may maintain the same. Thereby, the convenience of use of the projection apparatus and projection method is enhanced, and the application scenarios of the projection apparatus and projection method are expanded.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a projection apparatus with dynamic depth sensing according to an embodiment of this disclosure.

FIG. 2 is a flowchart illustrating a projection method according to an embodiment of this disclosure.

FIG. 3 is a schematic diagram illustrating adjusting a target object in a projection image according to a pixel size parameter according to an embodiment of this disclosure.

FIG. 4 is a schematic diagram illustrating adjusting a target object in a projection image according to a pixel position parameter according to an embodiment of this disclosure.

FIG. 5 is a schematic diagram illustrating an effective working distance according to an embodiment of this disclosure.

### DESCRIPTION OF THE EMBODIMENTS

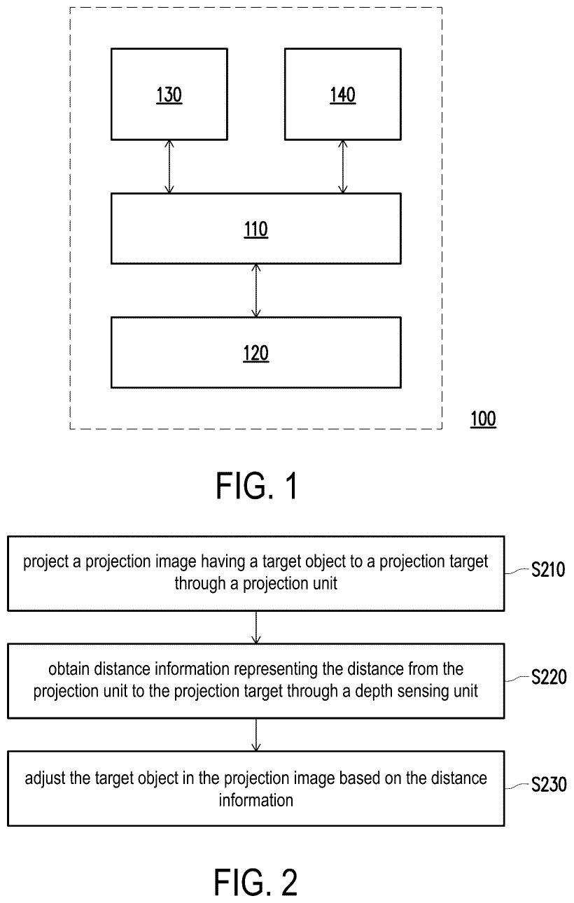

FIG. 1 is a schematic diagram illustrating a projection apparatus 100 with dynamic depth sensing according to an embodiment of this disclosure. In this embodiment, the projection apparatus 100 may include a processor 110, a storage media 120, a projection unit 130, and a depth sensing unit 140. The processor 110 may be coupled to the storage media 120, the projection unit 130, and the depth sensing unit 140.

The processor 110 can be, for example, a central processing unit, or other programmable general-purpose or special-purpose microprocessor, digital signal processor, programmable controller, application-specific integrated circuit, or other similar elements or a combination of the above elements.

The storage media 120 is used to store various software, data, and various program codes required for the operation of the projection apparatus 100, for example, a projection ratio parameter described later. The storage media 120 can be, for example, non-transitory fixed or removable random access memory, read-only memory, flash memory, hard disk, solid-state drive, or other similar elements or a combination of the above elements.

The projection unit 130 is used to project a projection image to a projection target. The projection target can be, for example, an overall area, a specific area, or any area corresponding to a wall or projection screen, etc., and this disclosure is not limited thereto. In this embodiment, the size of the projection image projected by the projection apparatus 100 is determined according to the distance between the projection unit 130 and the projection target and a projection ratio parameter. The projection ratio parameter may be represented as the following formula (1):

$$T = \frac{D}{W} \qquad ( 1 )$$

In formula (1), T is the projection ratio parameter, D is the distance parameter representing the distance between the projection unit 130 and the projection target, and W is the physical width of the projection image on the projection target. In this embodiment, the projection ratio parameter of the projection unit 130 of each projection apparatus 100 is a fixed value. That is, the projection apparatus 100 of this embodiment changes the projection image size through changing the distance between the projection unit 130 and the projection target, which is different from the projection systems of prior art that change the size of the projection image through changing the projection range parameter by hardware or software methods.

The depth sensing unit 140 is used to obtain the distance between the projection unit 130 and the projection target. The depth sensing unit 140 can be, for example, an ultrasonic distance sensor, a light detection and ranging (LiDAR) sensor, a structured light depth sensor, or other sensing devices that may sense the distance or depth between the projection unit 130 and the projection target, and this disclosure is not limited thereto.

In this embodiment, the depth sensing unit 140 is configured to maintain a fixed relative position relationship with the projection unit 130, and is configured to face the same direction with the same viewing angle as the projection unit 130. In this way, the accuracy of the distance between the projection unit 130 and the projection target measured by the depth sensing unit 140 may be improved.

FIG. 2 is a flowchart illustrating a projection method according to an embodiment of this disclosure, wherein the projection method may be implemented by the processor 110 of the projection apparatus 100 of FIG. 1.

In step S210, the processor 110 projects a projection image having a target object to the projection target through the projection unit 130. For example, the projection apparatus 100 may be configured with a universal serial bus (not shown), and the processor 110 of the projection apparatus 100 may receive an image signal having a target object from an external electronic device through the universal serial bus, and project a projection image corresponding to the image signal to the projection target.

In step S220, a distance parameter representing the distance from the projection unit 130 to the projection target is obtained through the depth sensing unit 140. In this embodiment, the value of the distance parameter may be, for example, in units of centimeters, but this disclosure is not limited thereto.

In step S230, the processor 110 adjusts the target object in the projection image based on the distance parameter. Specifically, the processor 110 monitors whether the distance parameter changes. When the distance parameter does not change, it represents that the size of the projection image does not change in this embodiment, so the size and position of the target object on the projection image do not change, and therefore it is not necessary to adjust the parameters corresponding to the target object. When the distance parameter changes, it represents that the size of the projection image changes, and therefore it is necessary to adjust the parameters corresponding to the target object, so that the physical size of the target object on the projection image and/or the distance from the projection image center remain unchanged.

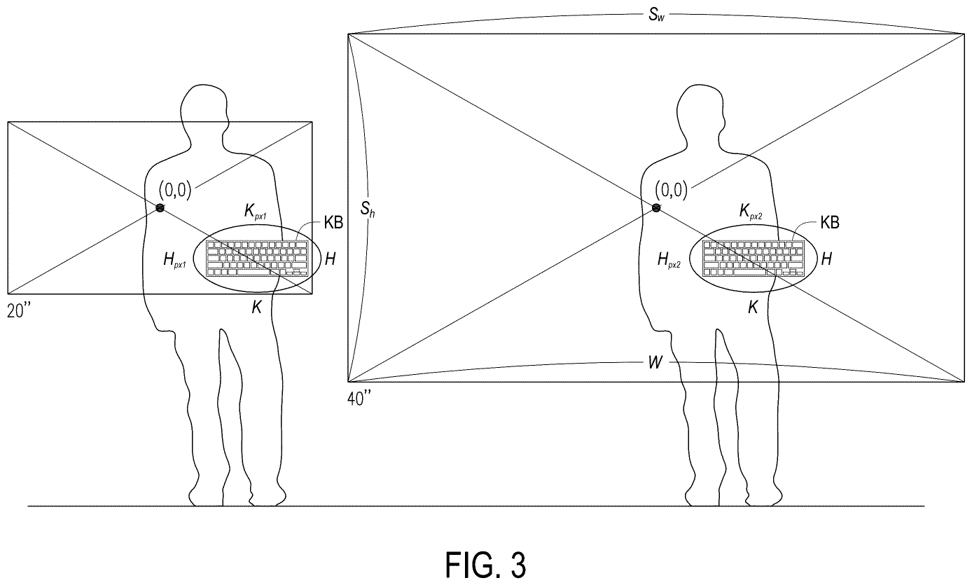

Referring to FIG. 3, FIG. 3 is a schematic diagram illustrating adjusting a target object in a projection image according to a pixel size parameter according to an embodiment of this disclosure. In FIG. 3, 20″ and 40″ are examples representing that the size of the projection image is 20 inches and 40 inches. (0,0) is the origin (center point) of the projection image. W is the physical width of the projection image on the projection target. KB is the target object. H is the target physical height parameter of the target object. K is the target physical width parameter of the target object. S_{W} is the resolution width parameter of the projection image, representing the pixel count of the projection image in the width direction. Sₕ is the resolution height parameter of the projection image, representing the pixel count of the projection image in the height direction. Kₚₓ₁ and Kₚₓ₂ are the pixel width parameters of the target object on the projection image, representing the pixel count of the target object in the width direction. Hₚₓ₁ and Hₚₓ₂ are the pixel height parameters of the target object on the projection image, representing the pixel count of the target object in the height direction.

In the embodiment of FIG. 3, the processor 110 of the projection apparatus 100, in response to determining that the distance parameter has changed, obtains a resolution width parameter corresponding to the projection image from the storage media 120; calculates a pixel size parameter corresponding to the target object based on the distance parameter and the resolution width parameter; adjusts the target object in the projection image according to the pixel size parameter.

Specifically, the processor 110 may obtain a target physical width parameter and a target physical height parameter corresponding to the target object and a projection ratio parameter corresponding to the projection unit 130 from the storage media.

The processor 110 may utilize the following formula (2) to calculate the pixel width parameter of the pixel size parameter:

$${K}_{px} = {S}_{W} \times F = {S}_{W} \times \frac{K \times T}{D} \qquad ( 2 )$$

In formula (2), Kₚₓ is the pixel width parameter of the target object on the projection surface, F is the width ratio that the target object occupies in the projection image. From formula (2), it can be known that the pixel width parameter Kₚₓ can be calculated according to the resolution width parameter S_{W} of the projection image, the target physical width parameter K, the projection ratio parameter T, and the distance parameter D.

The processor 110 may utilize the following formula (3) to calculate the pixel height parameter of the pixel size parameter:

$${H}_{px} = {K}_{px} \times \frac{H}{K} = {S}_{W} \times \frac{K \times T}{D} \times \frac{H}{K} = {S}_{W} \times \frac{H \times T}{D} \qquad ( 3 )$$

In formula (3), Hₚₓ is the pixel height parameter of the target object on the projection surface, K is the target physical width parameter of the target object. From formula (3), it can be known that the pixel height parameter Hₚₓ can be calculated according to the resolution width parameter S_{W} of the projection image, the target physical height parameter H, the projection ratio parameter T, and the distance parameter D.

That is, the processor 110 may adjust the target object in the projection image according to the pixel width parameter and pixel height parameter calculated by utilizing the above formulas (2) and (3). In this way, when the projection apparatus 100 projects projection images with projection sizes of 20″ and 40″ onto the projection target, the physical width and physical height of the target object on the projection target are the same as the physical width and physical height corresponding to the target physical width parameter and target height parameter.

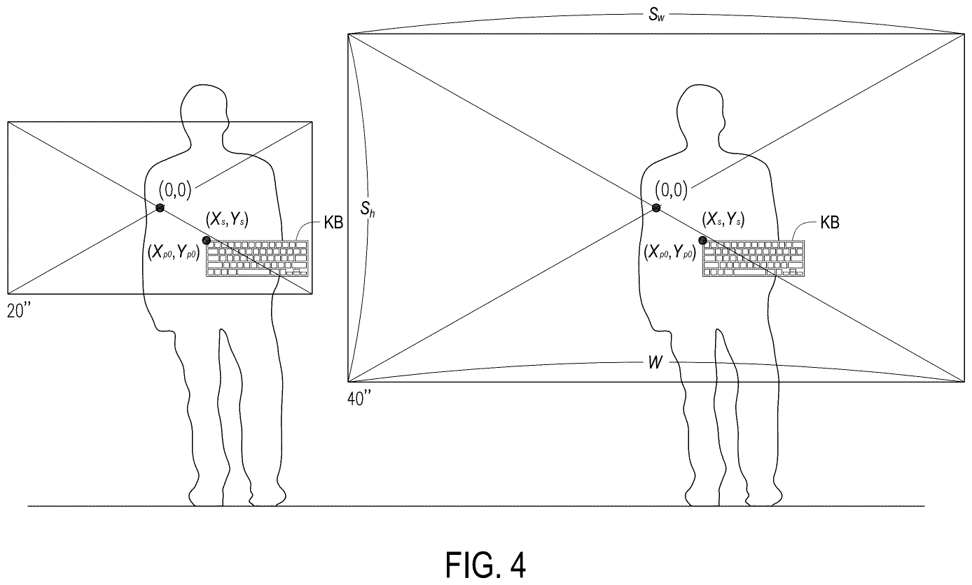

FIG. 4 is a schematic diagram illustrating adjusting a target object in a projection image according to a pixel position parameter according to an embodiment of this disclosure. For the same elements in the embodiment of FIG. 4 and the embodiment of FIG. 3, the same reference numerals are used and descriptions thereof are omitted. In FIG. 4, Xₛ is the pixel horizontal position parameter of the target object, representing the pixel count of the target object displaced on the horizontal coordinate relative to the projection image center on the projection image. Yₛ is the pixel vertical position parameter of the target object, representing the pixel count of the target object displaced on the vertical coordinate relative to the projection image center on the projection image. Xₚ₀ is the target physical horizontal position parameter of the target object with the projection image center as the origin. Yₚ₀ is the target physical vertical position parameter of the target object with the projection image center as the origin.

In the embodiment of FIG. 4, the processor 110 of the projection apparatus 100, in response to determining that the distance parameter has changed, obtains the resolution width parameter corresponding to the projection image from the storage media 120; calculates the pixel position parameter corresponding to the target object based on the distance parameter and the resolution width parameter; adjusts the target object in the projection image according to the pixel position parameter.

Specifically, the processor 110 may obtain from the storage media the target physical horizontal position parameter and target physical vertical position parameter corresponding to the target object with the projection image center as the origin, as well as the projection ratio parameter corresponding to the projection unit 130.

The processor 110 may utilize the following formula (4) to calculate the pixel horizontal position parameter of the pixel position parameter:

$${X}_{s} = \frac{{X}_{p 0}}{W} \times {S}_{W} = \frac{{X}_{p 0}}{\frac{D}{T}} \times {S}_{W} = {X}_{p 0} \times \frac{{S}_{W} \times T}{D} \qquad ( 4 )$$

In formula (4), Xₛ is the pixel horizontal position parameter, and W is the physical width of the projection image on the projection target. From formula (4), it can be known that the pixel horizontal position parameter Xₛ can be calculated according to the target physical horizontal position parameter Xₚ₀, the resolution width parameter S_{W} of the projection image, the projection ratio parameter T, and the distance parameter D.

The processor 110 may utilize the following formula (5) to calculate the pixel horizontal position parameter of the pixel position parameter:

$${Y}_{s} = \frac{{Y}_{p 0}}{L} \times {S}_{h} = {Y}_{p 0} \times \frac{{s}_{h}}{W \times \frac{{s}_{h}}{{s}_{W}}} = {Y}_{p 0} \times \frac{{S}_{W}}{W} = {Y}_{p 0} \times \frac{{S}_{W} \times T}{D} \qquad ( 5 )$$

In formula (5), Yₛ is the pixel vertical position parameter, L is the physical height of the projection image on the projection target, Sₕ is the resolution height parameter of the projection image, and W is the physical width of the projection image on the projection target. From formula (5), it can be known that the pixel vertical position parameter Yₛ can be calculated according to the target physical vertical position parameter Yₚ₀, the resolution width parameter S_{W} of the projection image, the projection ratio parameter T, and the distance parameter D.

That is, the processor 110 may adjust the target object in the projection image according to the pixel horizontal position parameter and pixel vertical position parameter calculated by utilizing the above formulas (4) and (5). In this way, when the projection apparatus 100 projects projection images with projection sizes of 20″ and 40″ onto the projection target, the physical horizontal position and physical vertical position of the target object on the projection target and the projection image center may be the same as the physical horizontal position and physical vertical position corresponding to the target physical horizontal position parameter and target vertical position parameter.

In an embodiment, the processor 110 of the projection apparatus 100 may adjust the target object in the projection image according to the pixel size parameter and the pixel position parameter. That is, the target object in the projection image is adjusted according to the calculated pixel width parameter and pixel height parameter, as well as the calculated pixel horizontal position parameter and pixel vertical position parameter. In this way, even when the distance between the projection apparatus 100 and the projection target is changed and the size of the projection image changes, the physical size of the target object on the projection target and the distance between the target object and the projection image center will not change. In other words, regardless of whether the distance between the projection apparatus 100 and the projection target is far or near, it does not affect the physical size of the specific target object in the projection image.

Regarding the application scene of the projection apparatus 100, in the application scene of utilizing the projection apparatus 100 to project a presentation as the projection image, a target object KB can be an interactive virtual keyboard. In addition, the projection apparatus 100 may allow the user to customize parameters related to the size and/or position of the interactive virtual keyboard. In this way, even when the distance between the projection apparatus 100 and the projection target is changed, the projection apparatus 100 may project the user-customized interactive virtual keyboard with fixed physical size and/or fixed distance from the projection image center, allowing the user to conveniently operate the interactive virtual keyboard when conducting the presentation.

The projection apparatus 100 of the disclosure is also suitable for other application scenes. For example, in the application scene of holding a touring exhibition, the target object KB can be a virtual painting, and the projection target can be a canvas in a picture frame. The curator may appropriately set parameters related to the size and/or position of the virtual painting. In this way, even when the distance between the projection apparatus 100 and the projection target needs to be changed due to the size of different exhibition venues, the virtual painting may be projected on the corresponding canvas with appropriate size and position.

When the distance between the projection unit 130 and the projection target is too close or too far, it will affect the quality of the projection image. Therefore, in an embodiment, in addition to adjusting the target object in the projection image, the processor 110 of the projection apparatus 100 may further determine whether the distance parameter obtained through the depth sensing unit 140 is within an effective working distance range. Specifically, when the processor 110 determines that the distance parameter is lower than a first threshold, it outputs a first warning message representing that the projection image will have a cropping problem. When determining that the distance parameter is higher than a second threshold, it outputs a second warning message representing that the clarity of the projection image will decrease. The first warning message and the second warning message may be displayed in the projection image as independent text messages or image messages, or warn the user through other methods, and the disclosure is not limited thereto.

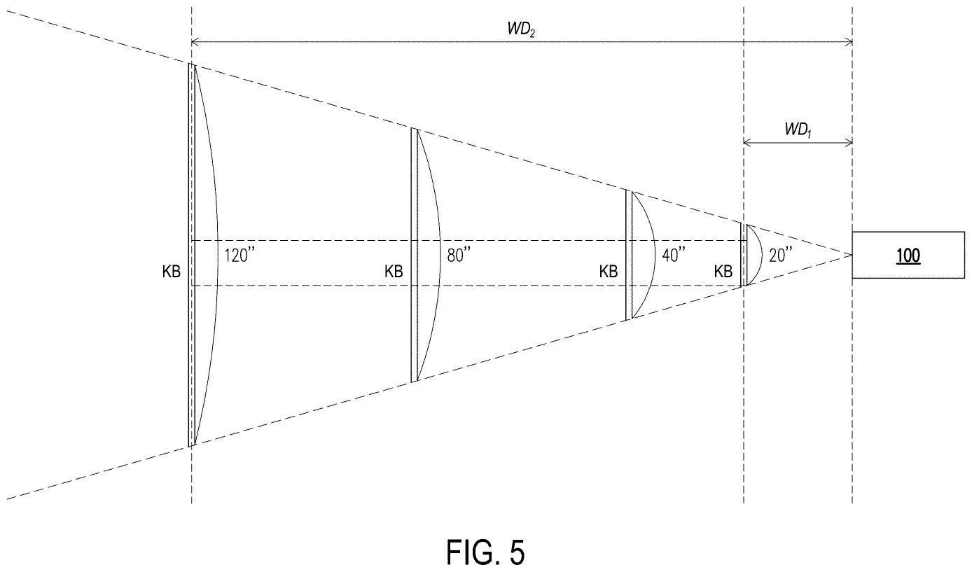

Referring to FIG. 5, FIG. 5 is a schematic diagram illustrating an effective working distance according to an embodiment of this disclosure. In FIG. 5, the working distance represented by WD₁ only includes invalid distance lower than the first threshold, the working distance represented by WD₂ includes effective working distance lower than the second threshold and higher than the first threshold as well as invalid working distance corresponding to WD₁, and 20″, 40″, 80″, and 120″ are examples representing that the size of the projection image is 20 inches, 40 inches, 80 inches, and 120 inches. In addition, FIG. 5 represents that under the change of projection image size, the physical size of the target object KB projected by the projection apparatus 100 on the projection target and the distance between the target object and the projection image center will not change. In this embodiment, WD₁ and the first threshold can be 50 centimeters, and WD₂ and the second threshold can be 300 centimeters, but the disclosure is not limited thereto. WD₁ and WD₂ as well as the respectively corresponding first threshold and second threshold may be determined according to the hardware specifications of the projection unit 130 and the target physical size of the target object.

In summary, the projection apparatus with dynamic depth sensing and the projection method of the disclosure may utilize the technology of projector combined with depth measurement and the concept of effective working distance to achieve that under any scaling size of the projection image, the size and relative position of content objects in the projection image may maintain the same. Thereby, the convenience of use of the projection apparatus and projection method is enhanced, and the application scenarios of the projection apparatus and projection method are expanded.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A projection apparatus with dynamic depth sensing, comprising:
a projection unit;
a depth sensing unit, disposed to maintain a fixed relative position relationship with the projection unit, and disposed with the projection unit to face the same direction at the same viewing angle; and
a processor, coupled to the projection unit and the depth sensing unit, and configured to:
project a projection image having a target object to a projection target through the projection unit;
obtain a distance parameter representing a distance from the projection unit to the projection target through the depth sensing unit; and
adjust the target object in the projection image based on the distance parameter.

2. The projection apparatus according to claim 1, wherein the projection apparatus further comprises a storage media coupled to the processor, and the processor is further configured to:
in response to determining that the distance parameter has changed, obtain a resolution width parameter corresponding to the projection image from the storage media;
based on the distance parameter and the resolution width parameter, calculate a pixel size parameter corresponding to the target object; and
according to the pixel size parameter, adjust the target object in the projection image.

3. The projection apparatus according to claim 2, wherein the processor is further configured to:
obtain a target physical width parameter and an aspect ratio parameter corresponding to the target object and a projection ratio parameter corresponding to the projection unit from the storage media;
according to the distance parameter, the resolution width parameter, the target physical width parameter, and the projection ratio parameter, calculate a pixel width parameter of the pixel size parameter; and
according to the pixel width parameter and the aspect ratio parameter, calculate a pixel height parameter of the pixel size parameter.

4. The projection apparatus according to claim 1, wherein the projection apparatus further comprises a storage media coupled to the processor, and the processor is further configured to:
in response to determining that the distance parameter has changed, obtain a resolution width parameter corresponding to the projection image from the storage media;
based on the distance parameter and the resolution width parameter, calculate a pixel position parameter corresponding to the target object; and
according to the pixel position parameter, adjust the target object in the projection image.

5. The projection apparatus according to claim 4, wherein the processor is further configured to:
obtain a target physical horizontal position parameter and a target vertical position parameter corresponding to the target object with a projection image center as origin, and a projection ratio parameter corresponding to the projection unit from the storage media;
according to the distance parameter, the resolution width parameter, the target physical horizontal position parameter, and the projection ratio parameter, calculate a pixel horizontal position parameter of the pixel position parameter; and
according to the distance parameter, the resolution width parameter, the target physical vertical position parameter, and the projection ratio parameter, calculate a pixel vertical position parameter of the pixel position parameter.

6. The projection apparatus according to claim 1, wherein the processor is further configured to:
when determining that the distance parameter is lower than a first threshold, output a first warning message; and
when determining that the distance parameter is higher than a second threshold, output a second warning message.

7. A projection method with dynamic depth sensing, adapted to a projection apparatus, the projection apparatus comprising a projection unit and a depth sensing unit, wherein the depth sensing unit is disposed to maintain a fixed relative position relationship with the projection unit, and is disposed with the projection unit to face the same direction at the same viewing angle, the projection method comprising:
projecting a projection image having a target object to a projection target through the projection unit;
obtaining a distance parameter representing a distance from the projection unit to the projection target through the depth sensing unit; and
adjusting the target object in the projection image based on the distance parameter.

8. The projection method according to claim 7, further comprising:
in response to determining that the distance parameter has changed, obtaining a resolution width parameter corresponding to the projection image from the storage media;
based on the distance parameter and the resolution width parameter, calculating a pixel size parameter corresponding to the target object; and
according to the pixel size parameter, adjusting the target object in the projection image.

9. The projection method according to claim 8, further comprising:
obtaining a target physical width parameter and an aspect ratio parameter corresponding to the target object and a projection ratio parameter corresponding to the projection unit;
according to the distance parameter, the resolution width parameter, the target physical width parameter, and the projection ratio parameter, calculating a pixel width parameter of the pixel size parameter; and
according to the pixel width parameter and the aspect ratio parameter, calculating a pixel height parameter of the pixel size parameter.

10. The projection method according to claim 7, further comprising:
in response to determining that the distance parameter has changed, obtaining a resolution width parameter corresponding to the projection image;
based on the distance parameter and the resolution width parameter, calculating a pixel position parameter corresponding to the target object; and
according to the pixel position parameter, adjusting the target object in the projection image.

11. The projection method according to claim 10, further comprising:
obtaining a target physical horizontal position parameter and a target vertical position parameter corresponding to the target object with a projection image center as origin, and a projection ratio parameter corresponding to the projection unit from the storage media;
according to the distance parameter, the resolution width parameter, the target physical horizontal position parameter, and the projection ratio parameter, calculating a pixel horizontal position parameter of the pixel position parameter; and
according to the distance parameter, the resolution width parameter, the target physical vertical position parameter, and the projection ratio parameter, calculating a pixel vertical position parameter of the pixel position parameter.

12. The projection method according to claim 7, further comprising:
when determining that the distance parameter is lower than a first threshold, outputting a first warning message; and
when determining that the distance parameter is higher than a second threshold, outputting a second warning message.
